(19) United States
(12) Patent Application Publication
(10) Pub. No.: US 2026/0246173 A1
(43) Pub. Date: Aug. 20, 2026

(54) ELECTRICAL CONTACT HAVING PRESS FIT PIN

(71) Applicant: TE Connectivity Solutions GmbH, Schaffhausen (CH)

(72) Inventor: Christopher Ryan Raybold, Middletown, PA (US)

(21) Appl. No.: 19/053,583

(22) Filed: Feb. 14, 2025

(51) Int. Cl. H01R 12/58; H01R 13/05

(52) U.S. Cl. CPC H01R 12/585; H01R 13/055

(57) ABSTRACT

An electrical contact includes a main body between a mating portion and a terminating portion. The main body includes a stamped metal structure. The mating portion configured to be mated to a mating contact. The terminating portion includes a compliant pin configured to be inserted into a hole of a substrate. The compliant pin includes a tip at a front of the compliant pin. The compliant pin includes a base at a rear of the compliant pin. The base extends from the main body. The compliant pin includes a bulge between the tip and the base. The bulge has a bulge width greater than a tip width of the tip. The bulge configured to interface with the substrate when inserted in the hole. The compliant pin includes an opening traversing the base, the bulge and the tip.

### BACKGROUND OF THE INVENTION

The subject matter herein relates generally to an electrical contact with a compliant section for making a solderless electrical connection with an electrical contact hole.

Solderless press-fit electrical contacts are commonly used for connecting an electrical connector assembly to a circuit board. One example of such an electrical contact includes a compliant contact pin that is shaped to form a pair of beams that join each other at their respective ends with a contact void between the beams. Some of these electrical contacts may be characterized as eye-of-needle electrical contacts. The beams are configured to engage an interior wall of an electrical contact hole, such as a plated through-hole in a circuit board, during a mounting operation. The configuration of the beams and the contact void allow the beams to be deflected radially inward by the interior wall as the contact pin is inserted into the plated through-hole. Outer surfaces of the beams form a frictional engagement (e.g., interference fit) with the plated through-hole. As such, an electrical connection between the electrical contact and the plated through-hole may be established without the use of solder and with a reduced likelihood of damage occurring to the plated through-hole and/or printed circuit board, which may occur when using rigid electrical contacts.

However, as the size of the contacts and the plated through-holes is reduced, the holding or retention force (resistance to pull-out) is reduced, often below the minimum designated retention force. The lower retention force is largely due to the fact that thinner sheet metal must be used. The need for a considerable retention force for small contacts that fit in very small holes has been increasing as contacts have become smaller to accommodate the need for higher densities of contacts. Additionally, the compliant pins are susceptible to cracking, such as through the beams at the contact void due to the small size of the compliant pins and the stamping tolerance when forming the contact void.

Accordingly, there is a need for an electrical contact with an improved compliant section.

### BRIEF DESCRIPTION OF THE INVENTION

In one embodiment, an electrical contact is provided and includes a main body between a mating portion and a terminating portion. The main body includes a stamped metal structure. The mating portion configured to be mated to a mating contact. The terminating portion includes a compliant pin configured to be inserted into a hole of a substrate. The compliant pin includes a tip at a front of the compliant pin. The compliant pin includes a base at a rear of the compliant pin. The base extends from the main body. The compliant pin includes a bulge between the tip and the base. The bulge has a bulge width greater than a tip width of the tip. The bulge configured to interface with the substrate when inserted in the hole. The compliant pin includes an opening traversing the base, the bulge and the tip.

In another embodiment, an electrical contact is provided and includes a main body between a mating portion and a terminating portion. The main body includes a stamped metal structure. The mating portion configured to be mated to a mating contact. The terminating portion includes a compliant pin configured to be inserted into a hole of a substrate. The compliant pin includes a tip at a front of the compliant pin. The compliant pin includes a base at a rear of the compliant pin. The base extends from the main body. The compliant pin includes a bulge between the tip and the base. The bulge has a bulge width greater than a tip width of the tip. The bulge configured to interface with the substrate when inserted in the hole. The compliant pin includes an opening extends between a first contact arm and a second contact arm. The first and second contact arms extend from the main body along the base, the bulge, and the tip. The first and second contact arms include first and second resilient contact sections and first and second engagement sections. The compliant pin includes an opening traversing the base. The bulge and the tip between the first and second resilient contact sections and first and second engagement sections. Upon insertion of the compliant pin into the hole of the substrate, the first and second engagement sections engaging each other to close the opening therebetween causing the first and second resilient contacting sections to move independently of the first and second engagement sections. The first and second engagement sections and the first and second resilient contacting sections are deformed and generate independent retention forces which are combined to generate the total retention force of the compliant pin.

In a further embodiment, an electrical connector is provided and includes a housing that has a mating end and a mounting end. The mating end configured to be mated with a mating electrical connector. The mounting end configured to be mounted to a substrate. The housing includes contact channels. The electrical connector includes electrical contacts received in the contact channels. Each electrical contact includes a main body between a mating portion and a terminating portion. The main body includes a stamped metal structure. The mating portion configured to be mated to a mating contact of the mating electrical connector. The terminating portion includes a compliant pin that extends from the mounting end of the housing configured to be inserted into a hole of the substrate. The compliant pin includes a tip at a front of the compliant pin and a base at a rear of the compliant pin extends from the main body. The compliant pin includes a bulge between the tip and the base has a bulge width greater than a tip width of the tip. The bulge configured to interface with the substrate when inserted in the hole. The compliant pin includes an opening traversing the base, the bulge and the tip.

### BRIEF DESCRIPTION OF THE DRAWINGS

FIG. 1 is a perspective view of an electrical connector in accordance with an exemplary embodiment including a plurality of electrical contacts.

FIG. 2 illustrates the terminating portion of the electrical contact in accordance with an exemplary embodiment.

FIG. 3 is a cross sectional view of the electrical contact in accordance with an exemplary embodiment showing the tip of the compliant pin partially loaded into the plated through-hole of the substrate.

FIG. 4 is a cross sectional view of the electrical contact in accordance with an exemplary embodiment showing the bulge of the compliant pin partially loaded into the plated through-hole of the substrate prior to compression of the bulge.

FIG. 5 is a cross sectional view of the electrical contact in accordance with an exemplary embodiment showing the bulge of the compliant pin partially loaded into the plated through-hole of the substrate with the bulge partially compressed.

FIG. 6 is a cross sectional view of the electrical contact in accordance with an exemplary embodiment showing the bulge of the compliant pin partially loaded into the plated through-hole of the substrate with the bulge fully compressed.

FIG. 7 is a cross sectional view of the electrical contact in accordance with an exemplary embodiment showing the compliant pin fully loaded into the plated through-hole of the substrate.

FIG. 8 is a graph showing representative force (N) versus displacement (mm) plots for the compliant pin of the electrical contact shown in FIG. 2 compared to conventional compliant pins.

FIG. 9 is a graph showing representative force versus recovery (mm) plots for the compliant pin of the electrical contact shown in FIG. 2 compared to conventional compliant pins.

FIG. 10 illustrates the complaint pin of the electrical contact in accordance with an exemplary embodiment.

FIG. 11 is a cross sectional view of the electrical contact in accordance with an exemplary embodiment showing the bulge of the compliant pin partially loaded into the plated through-hole of the substrate.

FIG. 12 is a cross sectional view of the electrical contact in accordance with an exemplary embodiment showing the compliant pin fully loaded into the plated through-hole of the substrate.

FIG. 13 is a graph showing representative force (N) versus displacement (mm) plots for the compliant pin of the electrical contact shown in FIG. 10 compared to conventional compliant pins.

FIG. 14 is a graph showing representative force versus recovery (mm) plots for the compliant pin of the electrical contact shown in FIG. 10 compared to conventional compliant pins.

FIG. 15 illustrates the complaint pin of the electrical contact in accordance with an exemplary embodiment.

FIG. 16 is a cross sectional view of the electrical contact in accordance with an exemplary embodiment showing the tip of the compliant pin partially loaded into the plated through-hole of the substrate.

FIG. 17 is a cross sectional view of the electrical contact in accordance with an exemplary embodiment showing the bulge of the compliant pin partially loaded into the plated through-hole of the substrate with the bulge partially compressed.

FIG. 18 is a cross sectional view of the electrical contact in accordance with an exemplary embodiment showing the bulge of the compliant pin partially loaded into the plated through-hole of the substrate with the bulge fully compressed.

FIG. 19 is a cross sectional view of the electrical contact in accordance with an exemplary embodiment showing the compliant pin fully loaded into the plated through-hole of the substrate.

FIG. 20 is a graph showing representative force (N) versus displacement (mm) plots for the compliant pin of the electrical contact shown in FIG. 15 compared to conventional compliant pins.

FIG. 21 is a graph showing representative force versus recovery (mm) plots for the compliant pin of the electrical contact shown in FIG. 15 compared to conventional compliant pins.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

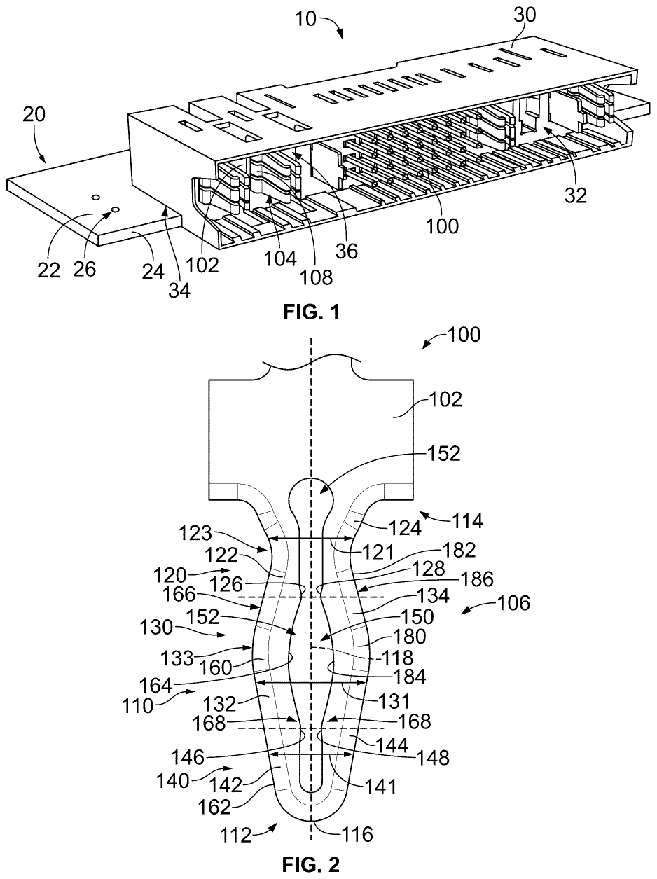

FIG. 1 is a perspective view of an electrical connector 10 in accordance with an exemplary embodiment including a plurality of electrical contacts 100. The electrical connector 10 is configured to be electrically connected to a component, such as a printed circuit board 20. The electrical connector 10 is configured to be connected to a mating electrical connector (not shown) at a separable mating interface. The electrical connector 10 transmits data and/or power between the components.

In an exemplary embodiment, the electrical connector 10 is a board connector or header connector terminated to the printed circuit board 20. In an exemplary embodiment, the electrical connector 10 is surface mounted to the printed circuit board 20. For example, the electrical connector 10 may be mounted to a surface 22 of a substrate 24 of the printed circuit board 20. The electrical contacts 100 of the electrical connector 10 may be press-fit to the substrate 24 by loading press-fit or compliant pins of the electrical connector 10 into holes 26, such as plated vias, of the substrate 24.

The electrical connector 10 includes a housing 30 holding the electrical contacts 100. The housing 30 may be manufactured from a dielectric material, such as a plastic material. For example, the housing 30 may be a molded plastic part, such as an injection molded part. The housing 30 extends between a mating end 32 and a mounting end 34. The mating end 32 is configured to be mated with the mating electrical connector. The mounting end 34 is configured to be mounted to the substrate 24. In the illustrated embodiment, the housing 30 is a right angle housing having a mounting end 34 perpendicular to the mating end 32. For example, the mounting end 34 may be located at a bottom of the housing and the mating end 32 may be located at a front of the housing. Other orientations are possible in alternative embodiments, such as having the mounting end 34 at a rear of the housing and/or the mating end 32 at a top of the housing.

The housing 30 may include alignment posts extending from the mounting end 34 configured to be received in alignment openings of the substrate 24 to position the electrical connector 10 relative to the substrate 24. The housing 30 may be secured to the substrate 24 using mounting tabs, fasteners, clips, latches, or other securing means. In other various embodiments, the electrical contacts 100 may be press-fit into the holes 26 in the substrate 24 to secure the electrical connector 10 to the substrate 24 by an interference fit.

In an exemplary embodiment, the housing 30 includes contact channels 36 that receive the electrical contacts 100. The electrical contacts 100 extend between the mating end 32 for mating with the mating electrical connector in the mounting end 34 for terminating to the substrate 24. The electrical contacts 100 may include signal contacts, ground contacts, power contacts, or other types of contacts. The electrical contacts 100 may be arranged in one or more rows and/or one or more columns. In other various embodiments, the housing 30 may include cavities that receive contact chicklets or contact wafers therein. The contact wafers may be overmolded lead frames having a dielectric overmolded body formed around a plurality of the electrical contacts 100.

Each electrical contact 100 includes a main body 102 extending between a mating portion 104 and a terminating portion 106 (FIG. 2). The electrical contact one hundred may be a right angle contact having the mating portion 104 perpendicular to the terminating portion 106. For example, the main body 102 may include a right angle bend or transition between the mating portion 104 and the terminating portion 106. In an exemplary embodiment, the electrical contact 100 is a stamped and formed contact. For example, the main body 102 includes a stamped metal structure 108. The mating portion 104 and the terminating portion 106 are stamped with the stamped metal structure 108. The mating portion 104 may include a pin, a socket, blade, or other type of mating interface. The terminating portion 106 extends from the mounting end 34 of the housing 30 to interface with the printed circuit board 20. In an exemplary embodiment, the terminating portion 106 includes a compliant pin (FIG. 2) configured to be terminated to the printed circuit board 20. For example, the compliant pin 110 may be press-fit into the corresponding hole 26 (for example, plated via) in the substrate 24. The compliant pin 110 may be an eye-of-the-needle pin.

FIG. 2 illustrates the terminating portion 106 of the electrical contact 100 in accordance with an exemplary embodiment. FIG. 2 illustrates the compliant pin 110 of the electrical contact 100. The compliant pin 110 extends between a front 112 and a rear 114. The rear 114 is located at the main body 102. The compliant pin 110 extends forward from the main body 102 to a distal end 116 at the front 112. The compliant pin 110 extends along a pin axis 118.

The complaint pin 110 includes a base 120 at the rear 114, a bulge 130 extending from the base 120, and a tip 140 at the front 112. The bulge 130 is located between the base 120 and the tip 140. The base 120 may be approximately the rear third (33% length) of the complaint pin 110. The bulge 130 may be approximately the middle third (33% length) of the complaint pin 110. The tip 140 may be approximately the front third (33% length) of the complaint pin 110. However, the base 120 and/or the bulge 130 and/or the tip 140 may have other lengths in alternative embodiments, such as the bulge 130 being the approximate middle half (50% length) of the compliant pin 110 and the base 120 and the tip 140 being the rear and front quarters (25% length), respectively, of the complaint pin 110.

The base 120 extends from the main body 102. In an exemplary embodiment, the main body 102 is wider than the base 120 and other portions of the compliant pin 110. For example, the compliant pin 110 has a narrow profile for fitting in the hole 26 in the substrate 24. The complaint pin 110 has a base width 121 along the base 120, a bulge width 131 along the bulge 130, and a tip width 141 along the tip 140. The base width 121 and/or the bulge width 131 and/or the tip width 141 may be variable. For example, exterior surfaces of the tip 140, the bulge 130, and the tip 140 may be angled, such as non-parallel to the longitudinal pin axis 118 of the compliant pin 110. The bulge 130 is bulged outward having a greater width than the base 120 and the tip 140. In various embodiments, the bulge width 131 may be approximately twice the base width 121 and/or the tip width 141. The tip width 141, particularly at the distal end 116, is selected to be narrower than the diameter of the plated through-hole 26 of the substrate 24 to allow initial loading and alignment of the complaint pin with the plated through-hole 26 prior to pressing the compliant pin 110 into the plated through-hole 26. The tip width 141 may be greater than the diameter of the hole 26 at the rear end of the tip 140 such that the rear end of the tip 140 interferes with the substrate prior to the bulge 130 to begin inward compression of the complaint pin 110 when the compliant pin 110 is inserted into the hole 26. The bulge width 131 is selected to be greater than (for example, wider than) the diameter of the plated through-hole 26 of the substrate 24 to ensure an interference fit in the plated through-hole 26. The bulge 130 is configured to be press-fit into the hole by an interference fit to create a mechanical and electrical connection to the substrate 24. For example, the bulge 130 is configured to interface with the substrate 24 when inserted in the hole 26. The tip 140 is narrower than the bulge 130 to guide loading of the compliant pin 110 into the hole 26 in the substrate 24. For example, the tip 140 may be wedge-shaped, being narrower at the distal end 116, to guide loading of the compliant pin 110 into the hole 26 in the substrate 24.

In an exemplary embodiment, the compliant pin 110 includes an opening 150 through a central portion of the compliant pin 110. The opening 150 is located between first and second contact arms 160, 180 located at first and second sides of the opening 150. In an exemplary embodiment, the complaint pin 110 is stamped to form the opening 150 by removing a central portion of the compliant pin 110, leaving the contact arms 160, 180 on opposite sides of the opening 150. In the illustrated embodiment, the first and second contact arms 160, 180 are mirror images of each other. However, the first and second contact arms 160, 180 may have different features and/or shapes in alternative embodiments. In an exemplary embodiment, the opening 150 traverses the base 120, the bulge 130 and the tip 140. For example, the opening 150 is continuous through the base 120, the bulge 130, and the tip 140. In other words, the opening 150 includes a base portion through the base 120, a bulge portion through the bulge 130, and a tip portion through the tip 140. The opening 150 may additionally transition into the main body 102. The first and second contact arms 160, 180 extend along the base 120, the bulge 130, and the tip 140. In an exemplary embodiment, the contact arms 160, 180 define an angular bowed compliant section. The first and second contact arms 160, 180 meet at the distal end 116. For example, the contact arms 160, 180 each include a base portion along the base 120, a bulge portion along the bulge 130, and a tip portion along the tip 140. The first and second contact arms 160, 180 may be separately joined to the main body 102. Alternatively, the first and second contact arms 160, 180 may meet or join along the base 120 prior to joining with the main body 102. Having the opening 150 extend along the tip 140 and the base 120 reduces the risk of cracking along the contact arms 160, 180. For example, the profile and shape allows for increased center punch size for tooling robustness and distributes stresses to minimize cracking while providing more normal force and recovery force for the contact arms 160, 180 compared to conventional compliant pins. Having the opening 150 extend along the tip 140 makes the tip 140 wider thus reducing the loading distance needed into the hole 26 before initial contact with the hole.

The opening 150 and the contact arms 160, 180 form a compliant section or portion configured to be mounted in the hole 26 (for example, plated through-hole) in the substrate 24. The compliant section is a part of an electrical contact 100 which is driven into the plated through-hole 26 and retained therein by the resilient characteristics of the complaint section. The force required to insert the compliant portion into the hole 26 and the force required to withdraw the compliant portion from the hole 26 are important characteristics of the compliant portion. The configuration and operation of the compliant portion contribute to both the force required to insert the compliant portion into the hole 26 and the force required to withdraw the compliant portion.

In an exemplary embodiment, the first contact arm 160 includes an exterior surface 162 along the outer edge of the first contact arm 160 and an interior surface 164 along an interior edge of the first contact arm 160. The interior surface 164 defines the opening 150. In an exemplary embodiment, the exterior surface 162 is bulged outward along the bulge 130 and tapered inward to the base 120 and the tip 140. For example, the exterior surface 162 includes a convex inflection point 133 along the bulge 130, wherein the exterior surface 162 is angled downward and obliquely from the inflection point 133 along the forward portion of the bulge 130 and along the tip 140 and wherein the exterior surface is angled upward and obliquely from the inflection point 133 along the rearward portion of the bulge 130 and along the base 120. In an exemplary embodiment, the exterior surface 162 includes a concave inflection point 123 along the base 120, wherein the exterior surface is angled obliquely from the inflection point 123. The exterior surface 162 along the base 120 may be angled inward from the main body 102 to the bulge 130, such as non-parallel to the longitudinal pin axis 118 of the compliant pin 110. The exterior surface 162 along the base 120 may have other shapes in alternative embodiments, such as an hour-glass shape. The exterior surface 162 along the tip 140 may be angled outward from the distal end 116 to the bulge 130, such as non-parallel to the longitudinal pin axis 118 of the compliant pin 110, such as to form a wedge-shaped tip. The exterior surface 162 along the tip 140 may have other shapes in alternative embodiments. The exterior surface 162 may have smooth transitions (for example, a continuous exterior surface) between the bulge 130 and the base 120 and the tip 140. The exterior surface 162 may have a curved profile, such as being curved at the front 112 (for example, curved at the distal end 116) and/or being curved at the bulge 130 and/or being curved at the rear (for example, curved at the transition from the base 120 to the main body 102). The curved transitions between the portions reduces cracking or breaking at the transitions. The interior surface 164 may have smooth transitions (for example, a continuous interior surface) between the bulge 130 and the base 120 and the tip 140. The smooth transitions between the portions reduces cracking or breaking at the transitions.

In an exemplary embodiment, the first contact arm 160 includes first resilient contact sections 166 and first engagement sections 168. The resilient contact sections 166 may be subject to resilient deformation during loading of the compliant pin 110 into the hole 26 in the substrate 24. For example, the resilient contact sections 166 are configured to be resiliently deformed inward when the complaint pin 110 is loaded into the hole 26 in the substrate 24. Resilient deformation is the ability of a material to absorb and release energy when it is deformed elastically. The resilient contact sections 166 of the complaint pin 110 have the ability to recover their shape after the deforming force or pressure is removed. The deformation creates an internal, spring biasing force in an outward direction to press the exterior surface 162 of the first contact arm 160 into interference contact with the plated through-hole 26 to create a mechanical and electrical connection with the plated through-hole 26. In an exemplary embodiment, the resilient contact sections 166 deform inwardly when press-fit into the hole 26 until the engagement sections 168 bottom out or bear against the second contact arm 180, thereby preventing further inward movement of the engagement sections 168. The engagement sections 168 effectively become fixed points, causing further movement or deformation of other resilient contact sections 166 to be independent of the further movement or deformation of the bottomed out or fixed resilient contact sections 166.

In an exemplary embodiment, the second contact arm 180 includes an exterior surface 182 along the outer edge of the second contact arm 180 and an interior surface 184 along an interior edge of the second contact arm 180. The interior surface 184 defines the opening 150. In an exemplary embodiment, the exterior surface 182 is bulged outward along the bulge 130 and tapered inward to the base 120 and the tip 140. For example, the exterior surface 182 includes a convex inflection point 133 along the bulge 130, wherein the exterior surface 182 is angled downward and obliquely from the inflection point 133 along the forward portion of the bulge 130 and along the tip 140 and wherein the exterior surface is angled upward and obliquely from the inflection point 133 along the rearward portion of the bulge 130 and along the base 120. In an exemplary embodiment, the exterior surface 182 includes a concave inflection point 123 along the base 120, wherein the exterior surface is angled obliquely from the inflection point 123. The exterior surface 182 along the base 120 may be angled inward from the main body 102 to the bulge 130, such as non-parallel to the longitudinal pin axis 118 of the compliant pin 110. The exterior surface 182 along the base 120 may have other shapes in alternative embodiments, such as an hour-glass shape. The exterior surface 182 along the tip 140 may be angled outward from the distal end 116 to the bulge 130, such as non-parallel to the longitudinal pin axis 118 of the compliant pin 110, such as to form a wedge-shaped tip. The exterior surface 182 along the tip 140 may have other shapes in alternative embodiments. The exterior surface 182 may have smooth transitions (for example, a continuous exterior surface) between the bulge 130 and the base 120 and the tip 140. The exterior surface 182 may have a curved profile, such as being curved at the front 112 (for example, curved at the distal end 116) and/or being curved at the bulge 130 and/or being curved at the rear (for example, curved at the transition from the base 120 to the main body 102). The curved transitions between the portions reduces cracking or breaking at the transitions. The interior surface 184 may have smooth transitions (for example, a continuous interior surface) between the bulge 130 and the base 120 and the tip 140. The smooth transitions between the portions reduces cracking or breaking at the transitions.

In an exemplary embodiment, the second contact arm 180 includes second resilient contact sections 186 and second engagement sections 188. The resilient contact sections 186 may be subject to resilient deformation during loading of the compliant pin 110 into the hole 26 in the substrate 24. For example, the resilient contact sections 186 are configured to be resiliently deformed inward when the complaint pin 110 is loaded into the hole 26 in the substrate 24. Resilient deformation is the ability of a material to absorb and release energy when it is deformed elastically. The resilient contact sections 186 of the complaint pin 110 have the ability to recover their shape after the deforming force or pressure is removed. The deformation creates an internal, spring biasing force in an outward direction to press the exterior surface 182 of the second contact arm 180 into interference contact with the plated through-hole 26 to create a mechanical and electrical connection with the plated through-hole 26. In an exemplary embodiment, the resilient contact sections 186 deform inwardly when press-fit into the hole 26 until the engagement sections 188 bottom out or bear against the engagement sections 168 of the first contact arm 160, thereby preventing further inward movement of the engagement sections 188. The engagement sections 188 effectively become fixed points, causing further movement or deformation of other resilient contact sections 186 to be independent of the further movement or deformation of the bottomed out or fixed resilient contact sections 186.

In an exemplary embodiment, the resilient contact sections 166, 186 include base resilient contact sections 122, 124 along the first and second contact arms 160, 180 of the base 120, bulge resilient contact sections 132, 134 along the first and second contact arms 160, 180 of the bulge 130, and tip resilient contact sections 142, 144 along the first and second contact arms 160, 180 of the tip 140. The resilient contact sections 166, 186 may be deformable (for example, flexible). The resilient contact sections 166, 186 are movable relative to each other, such as being able to be bent or flexed at transitions therebetween.

In an exemplary embodiment, the engagement sections 168, 188 include base engagement sections 126, 128 and tip engagement sections 146, 148. The base engagement sections 126, 128 are located along the first and second contact arms 160, 180 at the transitions between the base 120 and the bulge 130. In various embodiments, the base engagement sections 126, 128 protrude inwardly toward each other into the opening 150. For example, the width of the opening 150 at the base engagement sections 126, 128 may be less than the width of the opening at other sections. However, the base engagement sections 126, 128 may not protrude inwardly in alternative embodiments, rather merely including smooth radiused transitions along the contact arms 160, 180. The tip engagement sections 146, 148 are located along the first and second contact arms 160, 180 at the transitions between the tip 140 and the bulge 130. In various embodiments, the tip engagement sections 146, 148 protrude inwardly toward each other into the opening 150. For example, the width of the opening 150 at the tip engagement sections 146, 148 may be less than the width of the opening at other sections. However, the tip engagement sections 146, 148 may not protrude inwardly in alternative embodiments, rather merely including smooth radiused transitions along the contact arms 160, 180. The base 120 is defined rearward of the engagement sections 126, 128, such as between the engagement sections 126, 128 and the main body 102. The tip 140 is defined forward of the engagement sections 146, 148. The bulge 130 is defined between the base engagement sections 126, 128 and the tip engagement sections 146, 148.

The opening 150 extends along the base 120, the bulge 130, and the tip 140. The opening 150 may extend proximate to the distal end 116 to allow deformation or flexing of the first and second contact arms 160, 180 along substantially the entire length of the complaint pin 110. The opening 150 is located between the resilient contact sections 166, 186 and between the engagement sections 168, 188. In an exemplary embodiment, the compliant pin 110 has a thickness between the exterior surfaces 162, 182 and the interior surfaces 164, 184 defining the opening 150. The thickness of the contact arms 160, 180 may be approximately uniform along the base 120. For example, the interior surfaces 164, 184 may generally follow parallel to the exterior surfaces 162, 182. The thickness of the contact arms 160, 180 may be approximately uniform along the bulge 130. The thickness of the contact arms 160, 180 may be approximately uniform along the tip 140.

In an exemplary embodiment, the opening 150 may have a variable width along the length thereof. For example, the opening 150 may include one or more bulbed sections 152. The bulbed sections 152 are sections of increased width. In an exemplary embodiment, the bulge 130 includes one of the bulbed sections 152. The bulbed section 152 in the bulge 130 defines an eye of the opening (for example, defining an eye-of-the-needle complaint pin). In the illustrated embodiment, the base 120 includes one of the bulbed sections 152. The bulbed section 152 in the base 120 may extend into the main body 102. The bulbed section 152 in the base 120 reduces the thicknesses of the first and second contact arms 160, 180 at the transitions to the main body 102 to reduce the risk of breaking or cracking at the transitions to the main body 102.

In an exemplary embodiment, the first and second contact arms 160, 180 are compressible inward into the opening 150 when the compliant pin 110 is inserted into the hole 26. In an exemplary embodiment, the tip 140 is configured to be compressed inward to reduce the tip width 141. The bulge 130 is configured to be compressed inward to reduce the bulge width 131. The base 120 is configured to be compressed inward to reduce the base width 121.

Upon insertion of the compliant pin 110 into the hole 26 of the substrate 24, the first and second engagement sections 168, 188 engage each other to close the opening 150 at the engagement sections 168, 188 therebetween causing the first and second resilient contacting sections 166, 186 to move independently of the first and second engagement sections 168, 188. The first and second engagement sections 168, 188 and the first and second resilient contacting sections 166, 186 are deformed and generate independent retention forces which are combined to generate the total retention force of the compliant pin 110. In an exemplary embodiment, the compliant pin 110 is compressible inward such that the first and second engagement sections 168, 188 engage each other to close the opening 150 therebetween and define fulcrums that allow movement of the resilient contacting sections 166, 186 independent of each other, such as forward and/or rearward of the fulcrums. The fulcrums may be defined at the transition between the bulge 130 and the tip 140 and/or at the transition between the bulge 130 and the base 120.

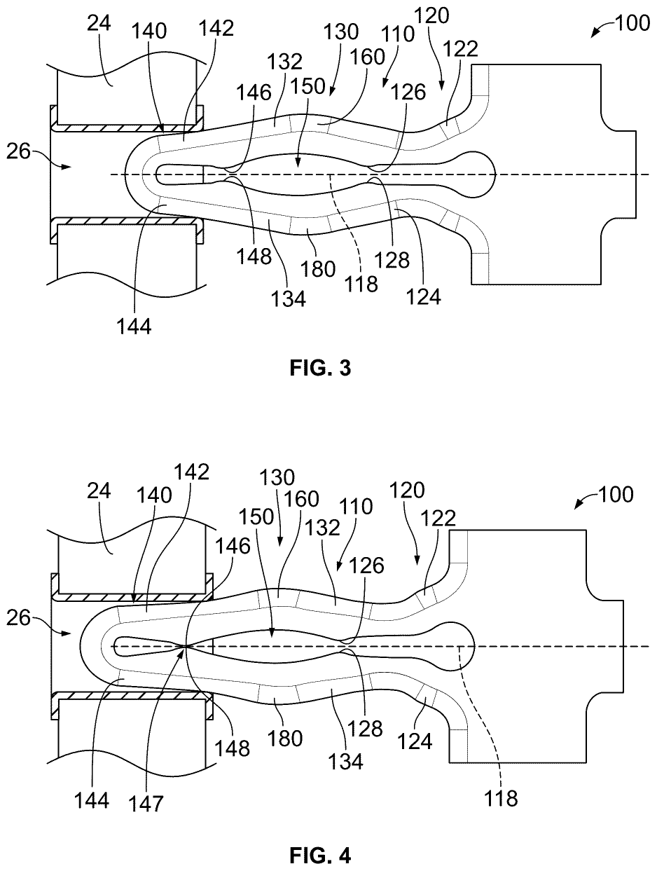

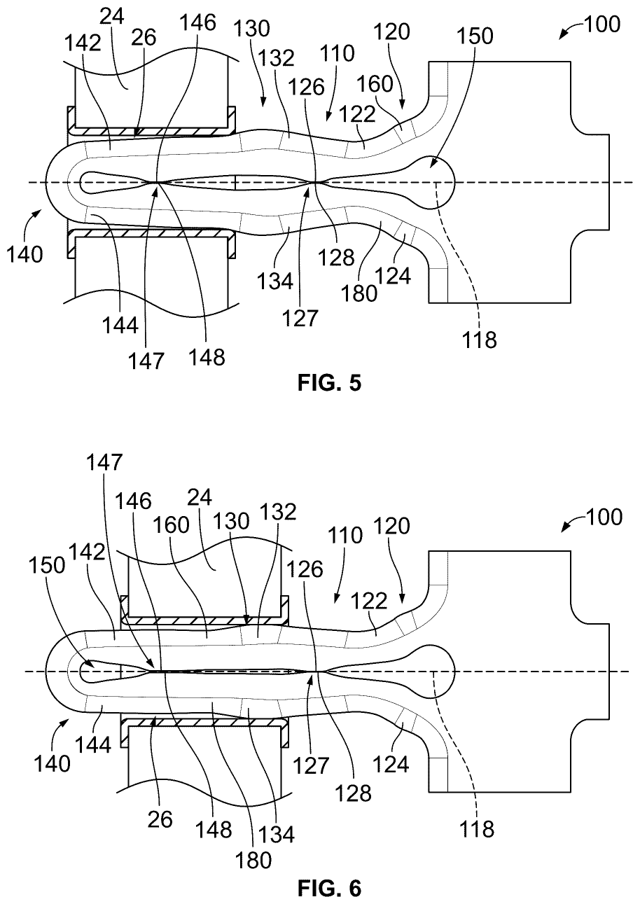

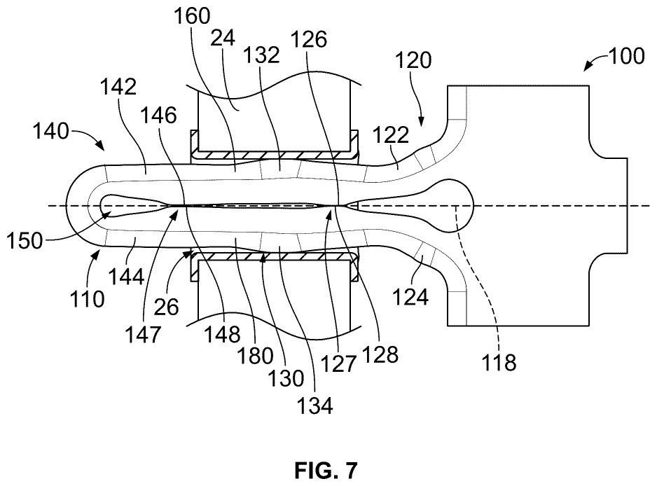

FIG. 3 is a cross sectional view of the electrical contact 100 in accordance with an exemplary embodiment showing the tip 140 of the compliant pin 110 partially loaded into the plated through-hole 26 of the substrate 24. FIG. 4 is a cross sectional view of the electrical contact 100 in accordance with an exemplary embodiment showing the bulge 130 of the compliant pin 110 partially loaded into the plated through-hole 26 of the substrate 24 prior to compression of the bulge 130. FIG. 5 is a cross sectional view of the electrical contact 100 in accordance with an exemplary embodiment showing the bulge 130 of the compliant pin 110 partially loaded into the plated through-hole 26 of the substrate 24 with the bulge 130 partially compressed. FIG. 6 is a cross sectional view of the electrical contact 100 in accordance with an exemplary embodiment showing the bulge 130 of the compliant pin 110 partially loaded into the plated through-hole 26 of the substrate 24 with the bulge 130 fully compressed. FIG. 7 is a cross sectional view of the electrical contact 100 in accordance with an exemplary embodiment showing the compliant pin 110 fully loaded into the plated through-hole 26 of the substrate 24.

During assembly, the compliant pin 110 is aligned with the hole 26. The tip 140 is initially loaded into the hole 26 and the complaint pin 110 is pushed downward to load into the hole 26. The tip 140 is narrower than the diameter of the hole 26 to allow positioning and alignment of the compliant pin 110 with the hole 26. The tip 140 is partially loaded into the hole 26 (FIG. 3) to allow the contact arms 160, 180 to enter the hole 26. The tip 140 is freely loaded into the hole 26 (without engagement with the hole 26 and/or compression of the contact arms 160, 180) until the tip resilient contact sections 142, 144 along the first and second contact arms 160, 180 at the tip 140 engage the wall of the hole 26. The engagement of the tip resilient contact sections 142, 144 with the wall of the hole 26 causes the tip 140 to resiliently deform inward, toward the pin axis 118 (FIG. 4). For example, the resilient contact sections 142, 144 of the contact arms 160, 180 are resiliently deformed inward. Having the opening 150 extend along the tip 140 reduces the risk of cracking along the contact arms 160, 180. Having the opening 150 extend along the tip 140 eases the stamping process. Having the opening 150 extend along the tip 140 makes the tip 140 wider thus reducing the loading distance needed into the hole 26 before initial contact with the hole.

Due to the size of the hole 26 and the width of the compliant pin 110, as insertion continues, the tip resilient contact sections 142, 144 of the contact arms 160, 180 continue to deform inwardly until the tip engagement sections 146, 148 of the first and second contact arms 160, 180 are moved into engagement (FIG. 4), thereby preventing further inward movement of the tip engagement sections 146, 148. It should be noted that the size (diameter) of the hole 26 and the width of the compliant pin 110 cause the total deflection of the first and second contact arms 160, 180 to vary. With the tip engagement sections 146, 148 engaged, the tip engagement sections 146, 148 effectively become a fixed point defining a tip fulcrum 147 causing further movement of the bulge resilient contact sections 132, 134 to be independent of the tip resilient contact sections 142, 144. The tip fulcrum 147 is located at the transition between the tip 140 and the bulge 130.

As insertion continues (FIG. 5), the bulge resilient contact sections 132, 134 continue to be moved or resiliently deformed inward and provide increased insertion forces and retention forces as the bulge 130 is deformed. The forces are accentuated in that the tip 140 is fixed at the tip engagement sections 146, 148. With continued insertion, the bulge resilient contact sections 132, 134 engage the wall of the hole 26. The engagement of the bulge resilient contact sections 132, 134 with the wall of the hole 26 causes the bulge 130 to resiliently deform inward, toward the axis 118. For example, the bulge resilient contact sections 132, 134 are resiliently deformed inward.

Due to the size of the hole 26 and the width of the compliant pin 110, as insertion continues, the bulge resilient contact sections 132, 134 of the contact arms 160, 180 continue to deform inwardly until the base engagement sections 126, 128 of the first and second contact arms 160, 180 are moved into engagement (FIG. 6), thereby preventing further inward movement of the base engagement sections 126, 128. It should be noted that the size (diameter) of the hole 26 and the width of the compliant pin 110 cause the total deflection of the first and second contact arms 160, 180 to vary. With the base engagement sections 126, 128 engaged, the base engagement sections 126, 128 effectively become a fixed point defining a base fulcrum 127 causing further movement of the bulge resilient contact sections 132, 134 to be independent of the base resilient contact sections 122, 124. The base fulcrum 127 is located at the transition between the base 120 and the bulge 130.

Depending upon the size of the opening or hole 26 into which the compliant pin 110 is inserted, portions of the compliant pin 110, such as along the bulge 130 are provided in electrical engagement with the plated through-hole 26. The use of the base and tip engagement sections 126, 128, 146, 148 allows the compliant pin 110 to operate as a traditional eye of the needle compliant portion when first inserted into the hole 26, thereby allowing for low insertion forces when the compliant pin 110 is initially inserted. However, once the base and tip engagement sections 126, 128, 146, 148 are in engagement, the bulge resilient contact sections 132, 134 act as independent spring members, thereby providing significantly more retention force than can be generated by known compliant pins. As the bulge resilient contact sections 132, 134 are moved inward about the fulcrums 147, 127 at the base and tip engagement sections 126, 128, 146, 148, and compressed to form a less curved path, the overall length of the compliant pin 110 may increase.

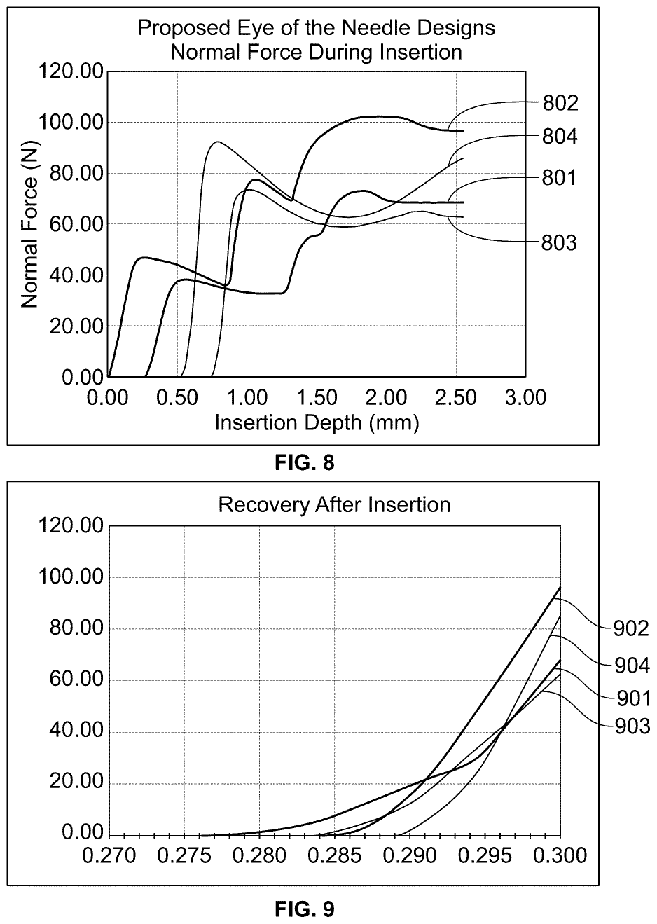

FIG. 8 is a graph showing representative force (N) versus displacement (mm) plots for the compliant pin 110 of the electrical contact 100 shown in FIG. 2 compared to conventional compliant pins. The plots include a first curve 801 showing a minimum force versus displacement curve for the compliant pin 110; a second curve 802 showing a maximum force versus displacement curve for the compliant pin 110; a third curve 803 showing a minimum force versus displacement curve for a conventional compliant pin; and a fourth curve 804 showing a maximum force versus displacement curve for a conventional compliant pin. While specific embodiments are shown, other embodiments may have different force versus displacement plots without departing from the scope of the invention.

The plots illustrate that insertion forces begin at a shallower insertion depth. The plots illustrate that lower insertion force is required during the initial insertion of the compliant portions into the holes compared to conventional pins. The force increases once the engagement sections engage to create a fixed or bottoming point, causing further movement or deformation of the resilient contact sections to be independent. In addition, the plots illustrate that the overall retention force for the compliant pin 110 is higher than conventional compliant pins, as sufficient recoverable energy is obtained due to the configuration of the compliant portions, thereby allowing the compliant portion of the compliant pin 110 to be used in harsh environments in which vibration and the like are present, for example, in automotive applications.

FIG. 9 is a graph showing representative force versus recovery (mm) plots for the compliant pin 110 of the electrical contact 100 shown in FIG. 2 compared to conventional compliant pins. The plots include a first curve 901 showing a minimum force versus recovery curve for the compliant pin 110; a second curve 902 showing a maximum force versus recovery curve for the compliant pin 110; a third curve 903 showing a minimum force versus recovery curve for a conventional compliant pin; and a fourth curve 904 showing a maximum force versus recovery curve for a conventional compliant pin. While specific embodiments are shown, other embodiments may have different force versus displacement plots without departing from the scope of the invention. The plots illustrate that recovery distance is improved for the complaint pin 110 compared to the conventional compliant pins. The recovery is improved due to the engagement sections defining fixed points or fulcrums between the various sections of the complaint pin 110.

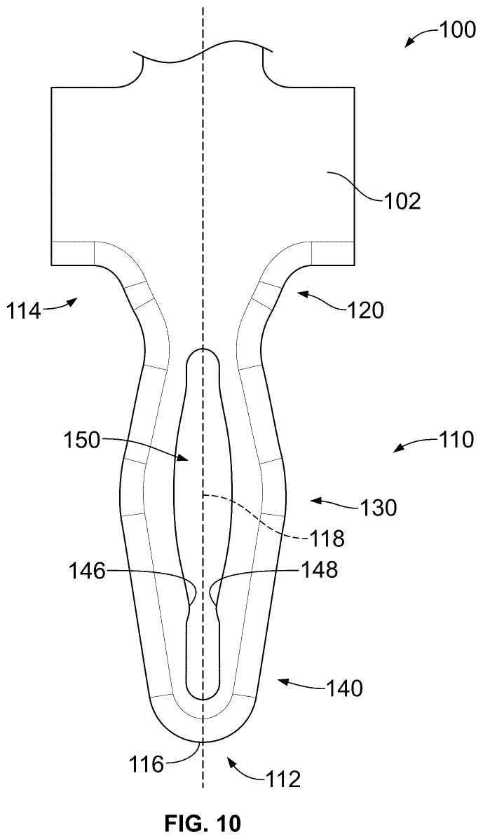

FIG. 10 illustrates the complaint pin 110 of the electrical contact 100 in accordance with an exemplary embodiment. The compliant pin 110 extends forward from the main body 102 to the distal end 116 along the pin axis 118. The complaint pin 110 includes the base 120 at the rear 114, the bulge 130 extending from the base 120, and the tip 140 at the front 112. The complaint pin 110 is similar to the embodiment shown in FIG. 2; however, the compliant pin 110 shown in FIG. 10 includes a shorter opening 150 and does not include the base engagement sections 126, 128, but rather only includes the tip engagement sections 146, 148. The complaint pin 110 has a simpler construction and stamping pattern compared to the embodiment shown in FIG. 2.

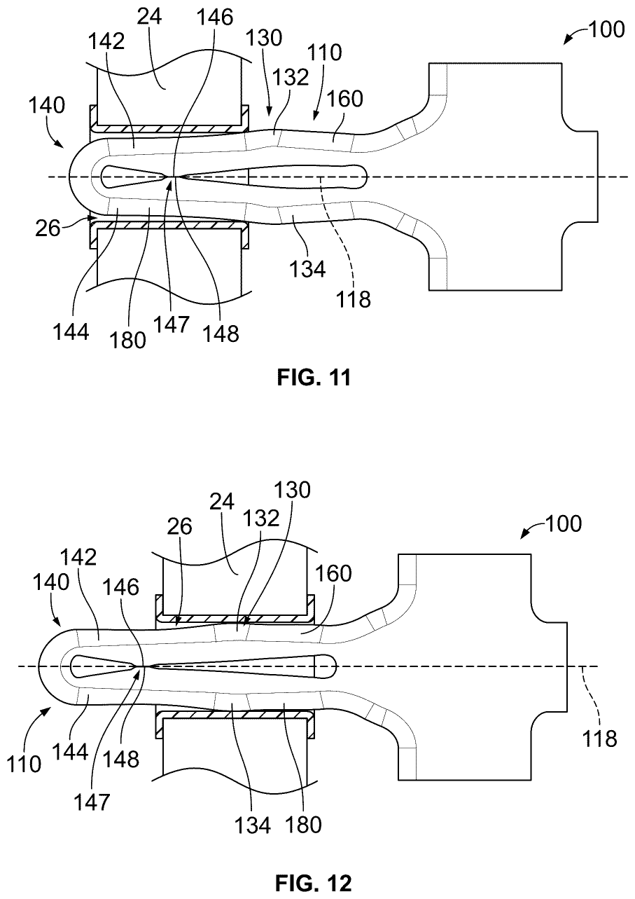

FIG. 11 is a cross sectional view of the electrical contact 100 in accordance with an exemplary embodiment showing the bulge 130 of the compliant pin 110 partially loaded into the plated through-hole 26 of the substrate 24. FIG. 12 is a cross sectional view of the electrical contact 100 in accordance with an exemplary embodiment showing the compliant pin 110 fully loaded into the plated through-hole 26 of the substrate 24.

During assembly, the compliant pin 110 is aligned with the hole 26 and the tip 140 is initially loaded into the hole 26 and the complaint pin 110 is pushed downward to load into the hole 26. The tip 140 is freely loaded into the hole 26 until the tip resilient contact sections 142, 144 along the first and second contact arms 160, 180 at the tip 140 engage the wall of the hole 26. The engagement of the tip resilient contact sections 142, 144 with the wall of the hole 26 causes the tip 140 to resiliently deform inward, toward the pin axis 118. The tip resilient contact sections 142, 144 deform inwardly until the tip engagement sections 146, 148 of the first and second contact arms 160, 180 are moved into engagement, thereby preventing further inward movement of the tip engagement sections 146, 148. With the tip engagement sections 146, 148 engaged, the tip engagement sections 146, 148 effectively become a fixed point defining the tip fulcrum 147 causing further movement of the bulge resilient contact sections 132, 134 to be independent of the tip resilient contact sections 142, 144.

As insertion continues, the bulge resilient contact sections 132, 134 continue to be moved or resiliently deformed inward and provide increased insertion forces and retention forces as the bulge 130 is deformed. The engagement of the bulge resilient contact sections 132, 134 with the wall of the hole 26 causes the bulge 130 to resiliently deform inward, toward the axis 118. For example, the bulge resilient contact sections 132, 134 are resiliently deformed inward. Portions of the compliant pin 110, such as along the bulge 130, are provided in electrical engagement with the plated through-hole 26. After the tip engagement sections 146, 148 are in engagement, the bulge resilient contact sections 132, 134 act as independent spring members, thereby providing significantly more retention force than can be generated by known compliant pins.

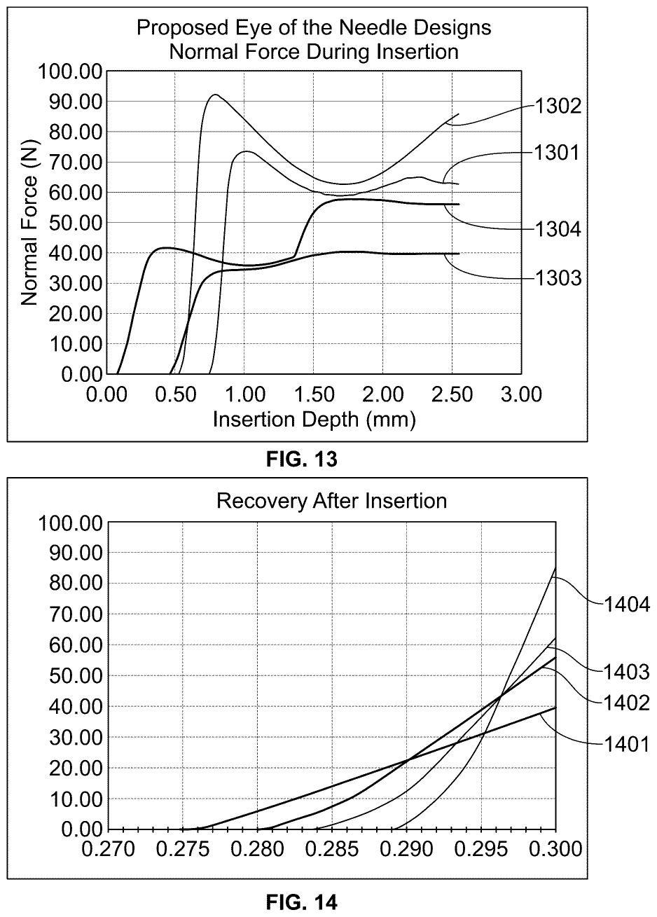

FIG. 13 is a graph showing representative force (N) versus displacement (mm) plots for the compliant pin 110 of the electrical contact 100 shown in FIG. 10 compared to conventional compliant pins. The plots include a first curve 1301 showing a minimum force versus displacement curve for the compliant pin 110; a second curve 1302 showing a maximum force versus displacement curve for the compliant pin 110; a third curve 1303 showing a minimum force versus displacement curve for a conventional compliant pin; and a fourth curve 1304 showing a maximum force versus displacement curve for a conventional compliant pin. While specific embodiments are shown, other embodiments may have different force versus displacement plots without departing from the scope of the invention.

The plots illustrate that insertion forces begin at a shallower insertion depth. The plots illustrate that lower insertion force is required during the initial insertion of the compliant portions into the holes compared to conventional pins. The force increases once the engagement sections engage to create a fixed or bottoming point, causing further movement or deformation of the resilient contact sections to be independent. In addition, the plots illustrate that the overall retention force for the compliant pin 110 is higher than conventional compliant pins, as sufficient recoverable energy is obtained due to the configuration of the compliant portions, thereby allowing the compliant portion of the compliant pin 110 to be used in harsh environments in which vibration and the like are present, for example, in automotive applications.

FIG. 14 is a graph showing representative force versus recovery (mm) plots for the compliant pin 110 of the electrical contact 100 shown in FIG. 10 compared to conventional compliant pins. The plots include a first curve 1401 showing a minimum force versus recovery curve for the compliant pin 110; a second curve 1402 showing a maximum force versus recovery curve for the compliant pin 110; a third curve 1403 showing a minimum force versus recovery curve for a conventional compliant pin; and a fourth curve 1404 showing a maximum force versus recovery curve for a conventional compliant pin. While specific embodiments are shown, other embodiments may have different force versus displacement plots without departing from the scope of the invention. The plots illustrate that recovery distance is improved for the complaint pin 110 compared to the conventional compliant pins. The recovery is improved due to the engagement sections defining fixed points or fulcrums between the various sections of the complaint pin 110.

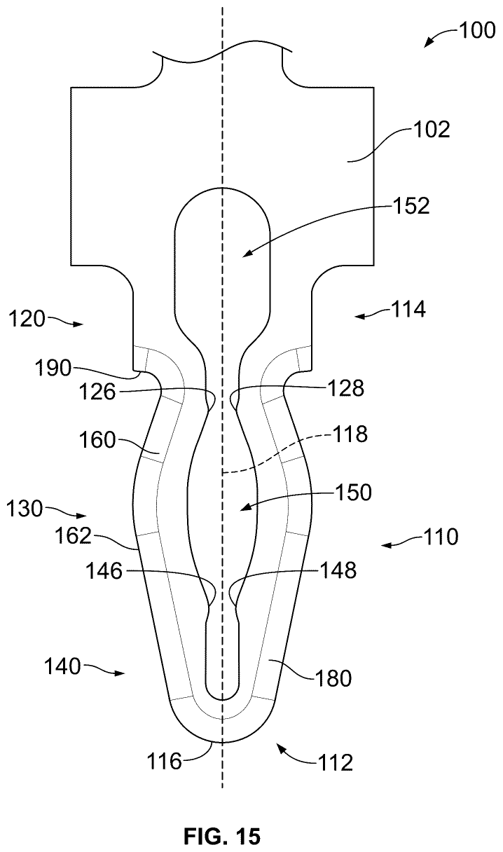

FIG. 15 illustrates the complaint pin 110 of the electrical contact 100 in accordance with an exemplary embodiment. The compliant pin 110 extends forward from the main body 102 to the distal end 116 along the pin axis 118. The complaint pin 110 includes the base 120 at the rear 114, the bulge 130 extending from the base 120, and the tip 140 at the front 112. The complaint pin 110 includes the base engagement sections 126, 128 and the tip engagement sections 146, 148.

The complaint pin 110 is similar to the embodiment shown in FIG. 2; however, the compliant pin 110 shown in FIG. 10 includes a longer or enlarged opening 150, particularly at the rear portion of the opening 150. In the illustrated embodiment, the base 120 includes the bulbed section 152, which increases the size of the opening 150. In the illustrated embodiment, the opening 150 extends into the main body 102 of the electrical contact 100. The opening 150 extends along the tip 140 and the base 120 to reduce the risk of cracking along the contact arms 160, 180. For example, the profile and shape allows for increased center punch size for tooling robustness and distributes stresses to minimize cracking while providing more normal force and recovery force for the contact arms 160, 180 compared to conventional compliant pins.

In an exemplary embodiment, the compliant pin 110 includes a stop ledge 190 remote from the main body 102. The stop ledge 190 is flared or turned outward from the exterior surface 162. For example, the stop ledge 190 may transition radially outward along a curved transition. The stop ledge 190 may be forward facing. The stop ledge 190 extends generally perpendicular to a longitudinal pin axis 118 of the compliant pin 110. The stop ledge 190 is configured to bottom out on the substrate 24 when the compliant pin 110 is inserted into the hole 26. The stop ledge 190 defines an insertion limit to stop insertion of the compliant pin 110 into the hole 26.

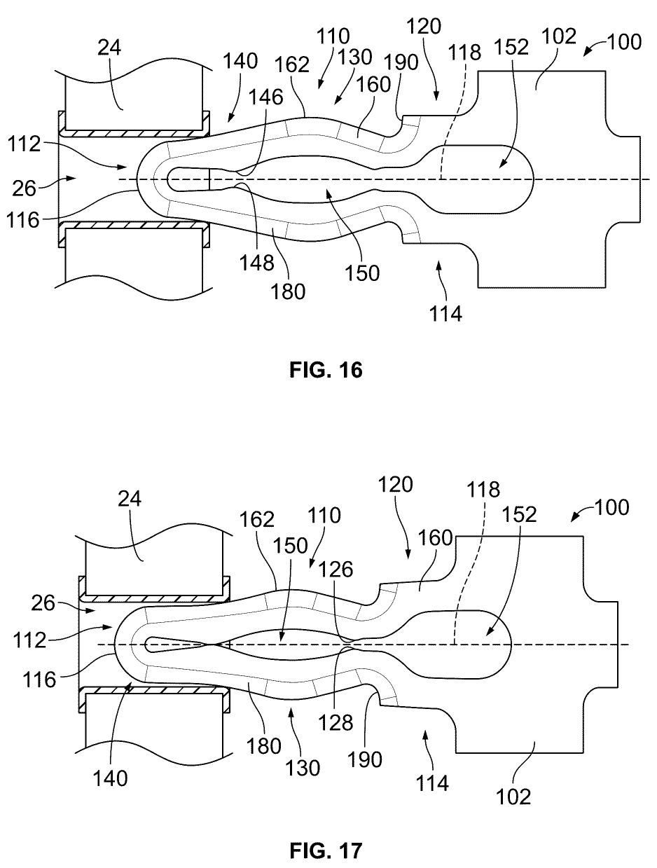

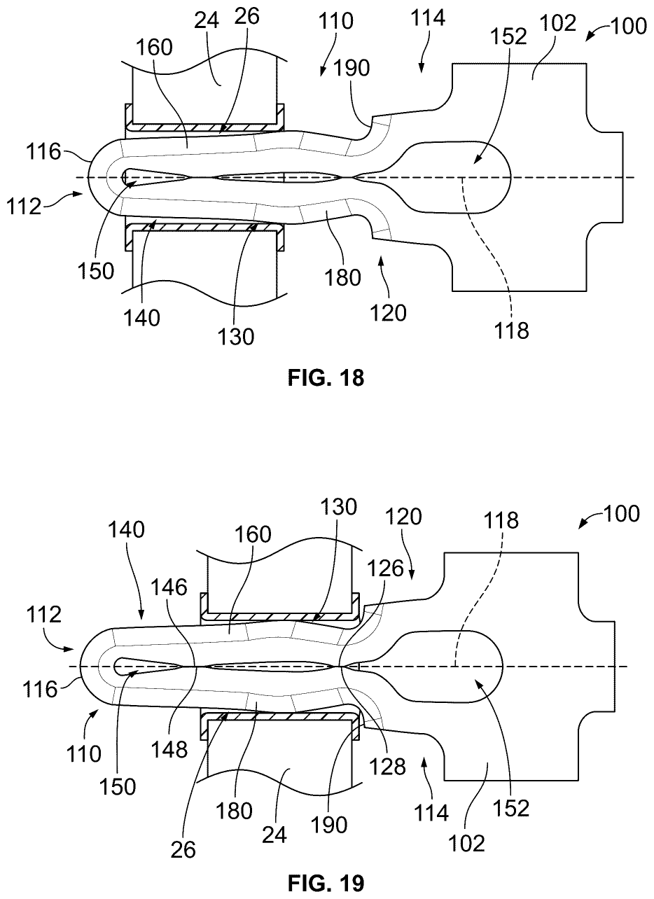

FIG. 16 is a cross sectional view of the electrical contact 100 in accordance with an exemplary embodiment showing the tip 140 of the compliant pin 110 partially loaded into the plated through-hole 26 of the substrate 24. FIG. 17 is a cross sectional view of the electrical contact 100 in accordance with an exemplary embodiment showing the bulge 130 of the compliant pin 110 partially loaded into the plated through-hole 26 of the substrate 24 with the bulge 130 partially compressed. FIG. 18 is a cross sectional view of the electrical contact 100 in accordance with an exemplary embodiment showing the bulge 130 of the compliant pin 110 partially loaded into the plated through-hole 26 of the substrate 24 with the bulge 130 fully compressed. FIG. 19 is a cross sectional view of the electrical contact 100 in accordance with an exemplary embodiment showing the compliant pin 110 fully loaded into the plated through-hole 26 of the substrate 24.

During assembly, the compliant pin 110 is aligned with the hole 26. The tip 140 is initially loaded into the hole 26 and the complaint pin 110 is pushed downward to load into the hole 26. The tip 140 is narrower than the diameter of the hole 26 to allow positioning and alignment of the compliant pin 110 with the hole 26. The tip 140 is partially loaded into the hole 26 (FIG. 16) to allow the contact arms 160, 180 to enter the hole 26. The tip 140 is freely loaded into the hole 26 (without engagement with the hole 26 and/or compression of the contact arms 160, 180) until the tip resilient contact sections 142, 144 along the first and second contact arms 160, 180 at the tip 140 engage the wall of the hole 26. The engagement of the tip resilient contact sections 142, 144 with the wall of the hole 26 causes the tip 140 to resiliently deform inward, toward the pin axis 118. For example, the resilient contact sections 142, 144 of the contact arms 160, 180 are resiliently deformed inward. Having the opening 150 extend along the tip 140 reduces the risk of cracking along the contact arms 160, 180. Having the opening 150 extend along the tip 140 eases the stamping process. Having the opening 150 extend along the tip 140 makes the tip 140 wider thus reducing the loading distance needed into the hole 26 before initial contact with the hole.

Due to the size of the hole 26 and the width of the compliant pin 110, as insertion continues, the tip resilient contact sections 142, 144 of the contact arms 160, 180 continue to deform inwardly until the tip engagement sections 146, 148 of the first and second contact arms 160, 180 are moved into engagement (FIG. 17), thereby preventing further inward movement of the tip engagement sections 146, 148. It should be noted that the size (diameter) of the hole 26 and the width of the compliant pin 110 cause the total deflection of the first and second contact arms 160, 180 to vary. With the tip engagement sections 146, 148 engaged, the tip engagement sections 146, 148 effectively become a fixed point defining a tip fulcrum 147 causing further movement of the bulge resilient contact sections 132, 134 to be independent of the tip resilient contact sections 142, 144. The tip fulcrum 147 is located at the transition between the tip 140 and the bulge 130.

As insertion continues (FIG. 18), the bulge resilient contact sections 132, 134 continue to be moved or resiliently deformed inward and provide increased insertion forces and retention forces as the bulge 130 is deformed. The forces are accentuated in that the tip 140 is fixed at the tip engagement sections 146, 148. With continued insertion, the bulge resilient contact sections 132, 134 engage the wall of the hole 26. The engagement of the bulge resilient contact sections 132, 134 with the wall of the hole 26 causes the bulge 130 to resiliently deform inward, toward the axis 118. For example, the bulge resilient contact sections 132, 134 are resiliently deformed inward.

Due to the size of the hole 26 and the width of the compliant pin 110, as insertion continues, the bulge resilient contact sections 132, 134 of the contact arms 160, 180 continue to deform inwardly until the base engagement sections 126, 128 of the first and second contact arms 160, 180 are moved into engagement (FIG. 18), thereby preventing further inward movement of the base engagement sections 126, 128. It should be noted that the size (diameter) of the hole 26 and the width of the compliant pin 110 cause the total deflection of the first and second contact arms 160, 180 to vary. With the base engagement sections 126, 128 engaged, the base engagement sections 126, 128 effectively become a fixed point defining the base fulcrum 127 causing further movement of the bulge resilient contact sections 132, 134 to be independent of the base resilient contact sections 122, 124. The base fulcrum 127 is located at the transition between the base 120 and the bulge 130.

Depending upon the size of the opening or hole 26 into which the compliant pin 110 is inserted, portions of the compliant pin 110, such as along the bulge 130 are provided in electrical engagement with the plated through-hole 26. The use of the base and tip engagement sections 126, 128, 146, 148 allows the compliant pin 110 to operate as a traditional eye of the needle compliant portion when first inserted into the hole 26, thereby allowing for low insertion forces when the compliant pin 110 is initially inserted. However, once the base and tip engagement sections 126, 128, 146, 148 are in engagement, the bulge resilient contact sections 132, 134 act as independent spring members, thereby providing significantly more retention force than can be generated by known compliant pins. As the bulge resilient contact sections 132, 134 are moved inward about the fulcrums 147, 127 at the base and tip engagement sections 126, 128, 146, 148, and compressed to form a less curved path, the overall length of the compliant pin 110 may increase.

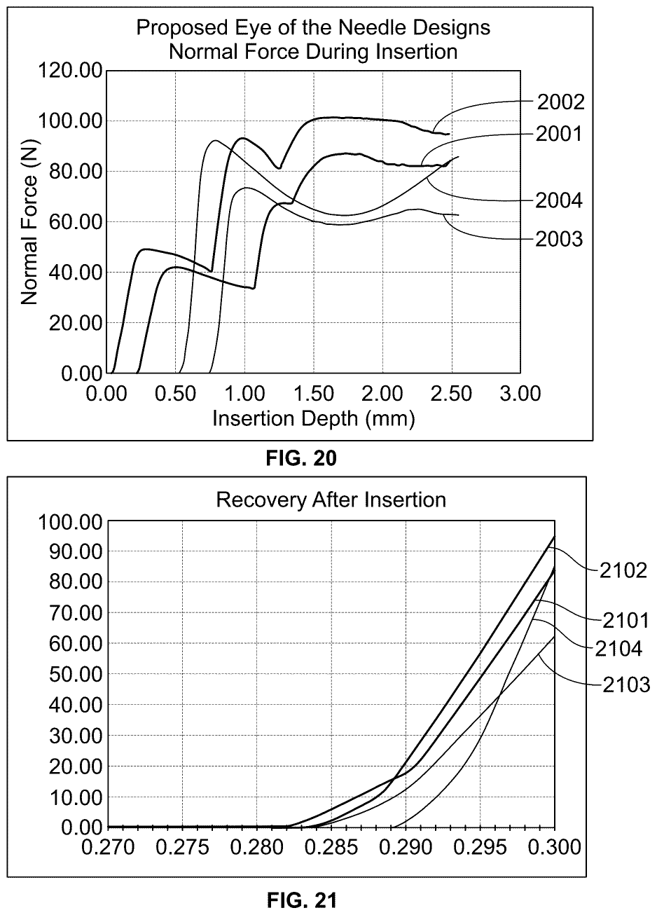

FIG. 20 is a graph showing representative force (N) versus displacement (mm) plots for the compliant pin 110 of the electrical contact 100 shown in FIG. 15 compared to conventional compliant pins. The plots include a first curve 2001 showing a minimum force versus displacement curve for the compliant pin 110; a second curve 2002 showing a maximum force versus displacement curve for the compliant pin 110; a third curve 2003 showing a minimum force versus displacement curve for a conventional compliant pin; and a fourth curve 2004 showing a maximum force versus displacement curve for a conventional compliant pin. While specific embodiments are shown, other embodiments may have different force versus displacement plots without departing from the scope of the invention.

The plots illustrate that insertion forces begin at a shallower insertion depth. The plots illustrate that lower insertion force is required during the initial insertion of the compliant portions into the holes compared to conventional pins. The force increases once the engagement sections engage to create a fixed or bottoming point, causing further movement or deformation of the resilient contact sections to be independent. In addition, the plots illustrate that the overall retention force for the compliant pin 110 is higher than conventional compliant pins, as sufficient recoverable energy is obtained due to the configuration of the compliant portions, thereby allowing the compliant portion of the compliant pin 110 to be used in harsh environments in which vibration and the like are present, for example, in automotive applications.

FIG. 21 is a graph showing representative force versus recovery (mm) plots for the compliant pin 110 of the electrical contact 100 shown in FIG. 15 compared to conventional compliant pins. The plots include a first curve 2101 showing a minimum force versus recovery curve for the compliant pin 110; a second curve 2102 showing a maximum force versus recovery curve for the compliant pin 110; a third curve 2103 showing a minimum force versus recovery curve for a conventional compliant pin; and a fourth curve 2104 showing a maximum force versus recovery curve for a conventional compliant pin. While specific embodiments are shown, other embodiments may have different force versus displacement plots without departing from the scope of the invention. The plots illustrate that recovery distance is improved for the complaint pin 110 compared to the conventional compliant pins. The recovery is improved due to the engagement sections defining fixed points or fulcrums between the various sections of the complaint pin 110.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical contact comprising:
a main body between a mating portion and a terminating portion, the main body including a stamped metal structure, the mating portion configured to be mated to a mating contact, the terminating portion including a compliant pin configured to be inserted into a hole of a substrate;
the compliant pin including a tip at a front of the compliant pin;
the compliant pin including a base at a rear of the compliant pin, the base extending from the main body;
the compliant pin including a bulge between the tip and the base, the bulge having a bulge width greater than a tip width of the tip, the bulge configured to interface with the substrate when inserted in the hole;
the compliant pin including an opening traversing the base, the bulge and the tip.

2. The electrical contact of claim 1, wherein the opening is continuous through the base, the bulge, and the tip.

3. The electrical contact of claim 1, wherein the compliant pin includes a first contact arm at a first side of the opening and a second contact arm at a second side of the opening, the first and second contact arms extending along the base, the bulge, and the tip.

4. The electrical contact of claim 3, wherein the first and second contact arms are compressible inward into the opening to reduce the tip width and the bulge width when the compliant pin is inserted into the hole.

5. The electrical contact of claim 3, wherein an exterior surface of the first contact arm along the tip is angled outward and an exterior surface of the second contact arm along the tip is angled outward nonparallel to the exterior surface of the first contact arm.

6. The electrical contact of claim 3, wherein the first and second contact arms include first and second resilient contact sections and first and second engagement sections, the opening located between the first and second resilient contact sections and first and second engagement sections, wherein upon insertion of the compliant pin into the hole of the substrate, the first and second engagement sections engaging each other to close the opening therebetween causing the first and second resilient contacting sections to move independently of the first and second engagement section, the first and second engagement sections and the first and second resilient contacting sections being deformed and generating independent retention forces which are combined to generate the total retention force of the compliant pin.

7. The electrical contact of claim 6, wherein the compliant pin is compressible inward such that the first and second engagement sections engage each other to close the opening at a fulcrum defined at the first and second engagement sections at a transition between the bulge and the tip.

8. The electrical contact of claim 1, wherein the tip is configured to be compressed inward to reduce the tip width and the bulge is configured to be compressed inward to reduce the bulge width when the compliant pin is inserted into the hole.

9. The electrical contact of claim 8, wherein the base is configured to be compressed inward to reduce a base width of the base when the compliant pin is inserted into the hole.

10. The electrical contact of claim 1, wherein the compliant pin has a thickness between an exterior surface and an interior surface defining the opening, the thickness being approximately uniform along the bulge and along the tip.

11. The electrical contact of claim 1, wherein the base includes a stop ledge remote from the main body, the stop ledge generally perpendicular to a longitudinal axis of the compliant pin configured to bottom out on the substrate when the compliant pin is inserted into the hole.

12. The electrical contact of claim 1, wherein the compliant pin is compressible inward to close the opening at a fulcrum defined at a transition between the bulge and the tip.

13. The electrical contact of claim 12, wherein the compliant pin is compressible inward to close the opening at a second fulcrum defined at a transition between the bulge and the base.

14. The electrical contact of claim 1, wherein the tip width is greater than a diameter of the hole such that the tip interferes with the substrate and is compressed inward when the compliant pin is inserted into the hole.

15. An electrical contact comprising:
a main body between a mating portion and a terminating portion, the main body including a stamped metal structure, the mating portion configured to be mated to a mating contact, the terminating portion including a compliant pin configured to be inserted into a hole of a substrate;
the compliant pin including a tip at a front of the compliant pin;
the compliant pin including a base at a rear of the compliant pin, the base extending from the main body;
the compliant pin including a bulge between the tip and the base, the bulge having a bulge width greater than a tip width of the tip, the bulge configured to interface with the substrate when inserted in the hole;
the compliant pin including an opening extending between a first contact arm and a second contact arm, the first and second contact arms extending from the main body along the base, the bulge, and the tip, the first and second contact arms including first and second resilient contact sections and first and second engagement sections, the compliant pin including an opening traversing the base, the bulge and the tip between the first and second resilient contact sections and first and second engagement sections;
wherein upon insertion of the compliant pin into the hole of the substrate, the first and second engagement sections engaging each other to close the opening therebetween causing the first and second resilient contacting sections to move independently of the first and second engagement sections; and
wherein the first and second engagement sections and the first and second resilient contacting sections are deformed and generate independent retention forces which are combined to generate the total retention force of the compliant pin.

16. The electrical contact of claim 15, wherein the compliant pin is compressible inward such that the first and second engagement sections engage each other to close the opening at a fulcrum defined at the first and second engagement sections at the transition between the bulge and the tip.

17. The electrical contact of claim 15, wherein the opening is continuous through the base, the bulge, and the tip.

18. The electrical contact of claim 15, wherein the first and second contact arms are compressible inward into the opening to reduce the tip width and the bulge width when the compliant pin is inserted into the hole.

19. The electrical contact of claim 15, wherein the tip is configured to be compressed inward to reduce the tip width and the bulge is configured to be compressed inward to reduce the bulge width when the compliant pin is inserted into the hole.

20. An electrical connector comprising:
a housing having a mating end and a mounting end, the mating end configured to be mated with a mating electrical connector, the mounting end configured to be mounted to a substrate, the housing including contact channels;
electrical contacts received in the contact channels, each electrical contact including a main body between a mating portion and a terminating portion, the main body including a stamped metal structure, the mating portion configured to be mated to a mating contact of the mating electrical connector, the terminating portion including a compliant pin extending from the mounting end of the housing configured to be inserted into a hole of the substrate, the compliant pin including a tip at a front of the compliant pin and a base at a rear of the compliant pin extending from the main body, the compliant pin including a bulge between the tip and the base having a bulge width greater than a tip width of the tip, the bulge configured to interface with the substrate when inserted in the hole, the compliant pin including an opening traversing the base, the bulge and the tip.
